(19) United States
(12) Patent Application Publication
(10) Pub. No.: US 2006/0102167 A1
(43) Pub. Date: May 18, 2006

(54) Pizza oven for grill

(76) Inventor: James P. Driscoll JR., Ayer, MA (US)

Correspondence Address: Brett N. Dorny, Esq.;LAW OFFICE OF BRETT N. DORNY, 321 Church Street, Northborough, MA, 01532, US

(21) Appl. No.: 10/988,757

(22) Filed: Nov. 15, 2004

(51) Int. Cl. F24C 1/16; A21B 1/52

(52) U.S. Cl. 126/275 R

(57) ABSTRACT

A pizza oven for a barbecue grill includes a base and a cover. The base has a plurality of sides extending therefrom and at least one open side. The cover has at least one side corresponding to the open side of the base. The base is placed upon the grill of the barbecue to be heated. The base and cover form an enclosed area for retaining hot air and for heating food. The cover has a temperature gauge and air vents for controlling the temperature in the oven.

### BACKGROUND OF THE INVENTION

1. Field Of the Invention

The present invention relates to accessories for barbecue grills. More particularly, it relates to an oven to be placed upon a barbecue grill or other heat source for heating pizza or other similar foods.

2. Discussion of Related Art

Cooking of foods on a barbecue grill has become an extremely popular method of food preparation. The typical barbecue grill includes a heat source, in the form of a gas burner or charcoal, and a grill suspended above the heat source. The grill serves as means to support the food being cooked over the heat source. In order to contain the heat, most modern barbecue grills also include a hinged lid or cover which provides a substantial enclosed space above the grill. The food is cooked by the heat from the heat source and from the hot air within the enclosed grill.

Grills are typically used outside, which avoids heating the home, particularly during summertime. They are often portable. They can be used to cook foods away from the home, such as for picnics or camping.

Typically, meats are cooked with a barbecue. Sometimes vegetables are also grilled. However, breads or other baked foods cannot be easily cooked with a grill. They require uniform heat within a defined temperature range. Grills lack the temperature controls to maintain a consistent temperature. The heat source creates an increase temperature from the bottom which can burn the lower parts of the food before the upper parts are cooked. When grilling, the foods are often rotated to allow even cooking. Baked goods cannot be rotated.

Pizza has become an increasingly popular food item both in the United States and in many other parts of the world. Nutritionally, pizza has many advantages since its taste is widely popular and, in a single food item, it can provide many necessary nutrients, including complex carbohydrates, vegetables, milk products and proteins. Pizza are often made in commercial establishments with dedicated ovens for cooking this type of food. Pizzas may also be cooked in home ovens. However, cooking a pizza with a barbecue grill is extremely difficult. The inconsistent heat within the grill causes the same problems for cooking pizzas as is does for other baked goods. Several grill accessories have been devised to cook different kinds of foods, including breads and pizzas.

U.S. Pat. No. 6,640,695 discloses a device to be placed upon an enclosed grill for cooking pizzas. The device includes a tile supported by a structure with legs. The legs sit upon the grill surface and keep the tile away from the surface. The heat source heats the tile and the surrounding air within the enclosed grill. The pizza is placed upon the tile and is cooked by the tile and the surrounding air. This device is limited to an enclosed grill. It is also difficult to control the cooking temperature.

U.S. Pat. No. 3,035,568 discloses a portable baking device which can be used with an outdoor charcoal fired grill. The device includes a lower plate with a skirt and a domed lid. The lower plate allows heat from a heat source to enter the device and to create a uniform temperature within the domed lid. However, the temperature is maintained by leakage of hot air due to manufacturing differences between the components.

U.S. Pat. No. 6,187,359 has a deep pan structure to be placed directly on the grill of a barbecue. The device also has vents or holes in the bottom of the pan to allow hot gases and smoke to penetrate. A pizza is placed upon a second pan placed on top of the extending sides of the device. It does not create a enclosed structure for creating a uniform temperature around the pizza. It relies upon the lid of an enclosed barbecue to contain the heat.

### SUMMARY OF THE INVENTION

The present invention is an oven for use on a barbecue grill for cooking or heating pizza and other backed foods. The present invention creates an area of substantially uniform temperature directly around the pizza or other food to be cooked. The temperature is monitored and can be controlled by the operator.

The oven of the present invention includes a substantially planar base with upstanding sides and a cover with another side extending therefrom. The base is positioned on the grill of a barbecue and is heated by the heat source of the barbecue. The cover is placed upon the base. The sides on the base hold the cover away from the bottom of the base. The space created by the base and the cover provides a mass of heated air for cooking the pizza. The side extending from the cover operates with the sides on the base to create a complete enclosure. When the cover is removed, the open space left by the side extending from the cover, allows easy access to the pizza or other food in the oven.

A temperature gauge is located on the exterior of the cover. A sensor in the cover operates to indicate the temperature in the oven. Vent holes are used to control the flow of hot air from the oven and, thus, the temperature in the oven. Closures are used to control the size of the vent holes.

### BRIEF DESCRIPTION OF THE DRAWINGS

FIG. 1 is a perspective view of an oven according to an embodiment of the present invention.

FIG. 2 is a perspective view of a cover for an oven according to an embodiment of the present invention.

FIG. 3 is a perspective view of a base for an oven according to an embodiment of the present invention.

FIG. 4 is a bottom view of the cover of FIG. 2

### DETAILED DESCRIPTION

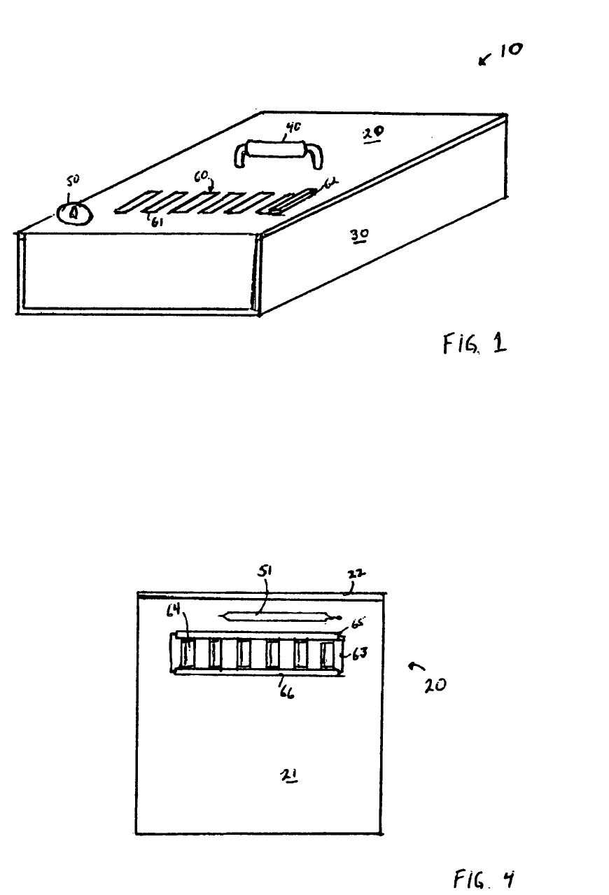

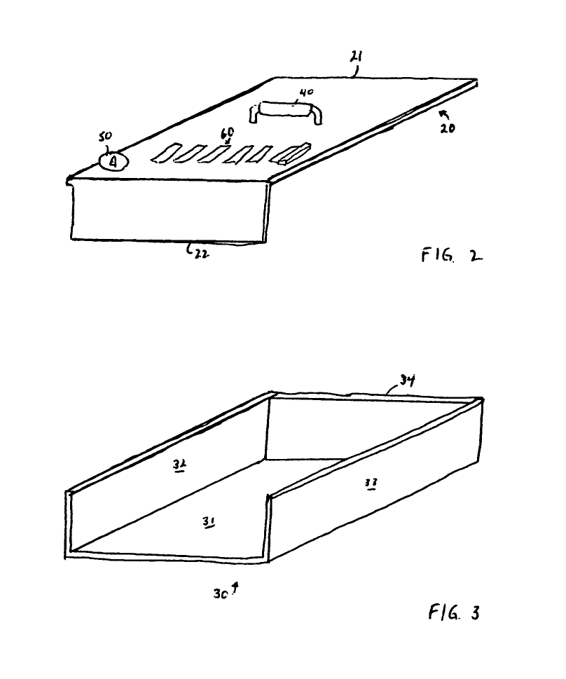

The present invention relates to an oven for cooking a pizza or other food on a grill or other heat source. As illustrated in FIGS. 1-3, the oven 10 of the present invention includes a base 30 and a cover 20. The base 20 includes a substantially planar bottom 31 and one or more sides 32, 33, 34 extending from the bottom 31. The cover 20 includes a top 21 and one or more sides 22. The top 21 and bottom 31 are of similar size and shape. The cover 20 sits on the base 30 to define an enclosed area bounded by the top 21, bottom 31, sides on the base 32, 33, 34 and sides on the cover 22. A handle 40 is attached to an upper surface of the cover 20 so that it can be removed.

According to an embodiment of the invention as illustrated in FIG. 1, the base 30 and cover 20 are substantially rectangular in shape, and preferably, square. The base 30 has three sides which are perpendicular to the bottom 31. The cover 20 has one side 22 substantially perpendicular to the top 21. The sides of the base 30 and of the cover 20 have approximately the same depth. The oven 10 is illustrated with three sides 32, 33, 34 on the base 30 and one side 22 on the cover 20. However, any number of sides could be attached to the cover or the base. Preferably, at least one side is attached to the cover 20 so that an open space remains to access the base 30 when the cover 20 is removed. Furthermore, the sides may be other than straight or a number of sides more or less than four may be used, depending upon the shape of the base 30 and cover 20.

The base 30 and cover 20 are of a metal, such as stainless steel. All or part of the base 30 and cover 20 may be of other materials, such as ceramic or tile. The material should be of a type which allows heat to penetrate to the interior of the oven 10 and to maintain hot air within the oven. The components of the oven may be formed in any known manner for working the materials from which it is made.

The base 30 of the oven 10 is placed upon the grill of a barbecue and the cover 20 is placed over the base 30. Heat from the heat source of the barbecue heats the bottom 31 of the base 30. Heating of the bottom 31 causes the air within the oven 10 to be heated. The cover 20 keeps the hot air within the enclosure of the oven. A pizza or other food is placed on the bottom 31 of the base 30. The open side of the base 30 allows easy access to the pizza or other food. The cover 20 is placed over the base until cooking is complete.

The cover 20 also includes a temperature gauge 50 and air vents 60 to control the cooking temperature of the oven 10. FIG. 4 is a view of the bottom of the cover 20 within the oven. As illustrated in FIG. 4, a temperature sensor 51 is placed along the front edge of the cover, towards the side 22. The temperature sensor 51 is connected through the top 21 of the cover 20 to the temperature gauge 50 on the exterior of the cover 20. The temperature sensor 51 measures the temperature of the air in the oven 10 and the temperature is displayed on the gauge 50. Although the temperature sensor 51 is illustrated as being positioned parallel to the side 22 of the cover 20, it may be positioned in any direction and anywhere along the cover 20. Additionally, the temperature sensor 51 and the temperature gauge 50 could be attached to the base 30.

The air vents 60 include a plurality of holes 61 formed in the top 21 of the cover 20. A closure plate 63 is positioned below the holes 61. The closure plate 63 has a plurality of holes 64 formed therethrough corresponding to the plurality of holes 61 in the top 21. The closure plate 63 is retained to the top 21 by channels 65, 66 positioned on either side. The closure plate 63 can slide within the channels 65, 66. A handle 62 is attached to the closure plate and extends through one of the holes 61 on the top 21. The handle 62 is used to more the closure plate 63 so that all or any portion of the holes 61 in the top 21 are blocked or open. Opening a portion of the holes 61 allows some of the hot air in the oven to escape. Escaping air lowers the temperature in the oven. The temperature of the oven 10 is controlled by moving the closure plate 63 so that a desired amount of air is allowed to escape.

Having described at least one embodiment of the invention, various modifications, adaptations, additions and extensions will be readily apparent to those of skill in the art. Such modifications, adaptations, additions and extensions are considered to be within the scope of the invention, which is not limited except as to the claims hereto.

1. A oven to be placed above a heat source comprising:
a base including a substantially planar bottom and at least one base side extending from the bottom; and
a cover engaging with the base, the cover including a top and at least one cover side extending from the top; and
wherein the at least one base side and at least one cover side are arranged to form an enclosed space between the bottom and the top when the cover is engaged with the base.

2. The oven according to claim 1, wherein the base can be disposed above the heat source.

3. The oven according to claim 1, wherein the cover further includes a handle extending from the top in a direction opposite the at least one side.

4. The oven according to claim 1, wherein the cover further includes:
at least one of hole formed in a portion of the top;
a closure plate attached to the top so as to be moveable from a first position in which it blocks the at least one hole and a second position in which it does not block the at least one hole.

5. The oven according to claim 4, wherein the at least one hole includes a plurality of holes.

6. The oven according to claim 4, wherein the closure plate is moveable to at least one position between the first position and the second position such that a portion of the at least one hole is blocked.

7. The oven according to claim 1, wherein the bottom is square and the top is square.

8. The oven according to claim 1, wherein:
the bottom has a rectangular shape;
the top has a rectangular shape; and
the base has at least two base sides.

9. The oven according to claim 8, wherein the base has at least three base sides.

10. The oven according to claim 1, wherein the cover further includes:
a temperature sensor positioned so as to be within the enclosed space; and
a temperature gauge connected to the temperature sensor, positioned so as to be outside of the enclosed space.

11. The oven according to claim 1, wherein the heat source is a barbecue grill.
